(19) United States
(12) Patent Application Publication
(10) Pub. No.: US 2010/0123631 A1
(43) Pub. Date: May 20, 2010

(54) Multi-band Antenna for a Wireless Communication Device

(76) Inventors: Cheng-Wei Chang, Taipei Hsien (TW); Chih-Liang Hung, Taipei Hsien (TW); Wei-Shan Chang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/503,084

(22) Filed: Jul. 15, 2009

(30) Foreign Application Priority Data
Nov. 17, 2008 (TW) 097144350

(51) Int. Cl. H01Q 1/36; H01Q 1/48; H01Q 5/00

(52) U.S. Cl. 343/700 MS; 343/846

(57) ABSTRACT

A multi-band antenna for a wireless communication device includes a grounding unit coupled to a ground, a first radiating unit, a connecting unit having a first terminal coupled to the first radiating unit and a second terminal, a feeding unit coupled between the second terminal of the connecting unit and the grounding unit for receiving feeding signals, a shorting unit coupled between the second terminal of the connecting unit and the grounding unit, a second radiating unit coupled to the shorting unit.

### BACKGROUND OF THE INVENTION

1. Field of the Invention

The present invention is related to a multi-band antenna for a wireless communication device, and more particularly, to a multi-band antenna capable of providing extra signal paths with an extra radiating unit on a shorting unit.

2. Description of the Prior Art

An antenna is utilized for transmitting or receiving radio waves, to transmit or exchange radio signals. An electronic products having a wireless communication function, such as a notebook computer, a personal digital assistant, etc, usually accesses wireless networks via a build-in antenna. Therefore, to realize convenient wireless network access, an ideal antenna should have a wide bandwidth and a small size, to meet a main stream of reducing a size of a portable communication device and integrating an antenna into a notebook computer. In addition, with the advancement of the wireless communication technology, different wireless communication systems may have different operating frequencies. Therefore, an ideal antenna is expected to be a single antenna covering every band used in different wireless communication networks.

### SUMMARY OF THE INVENTION

It is therefore a primary objective of the claimed invention to provide a multi-band antenna for a wireless communication device.

The present invention discloses a multi-band antenna for a wireless communication device comprising a grounding unit, coupled to a ground, a first radiating unit, a connecting unit, comprising a first end coupled to the first radiating unit, and a second end, a feeding unit, coupled between the second end of the connecting unit and the grounding unit, for receiving feed signals, a shorting unit, coupled between the second end of the connecting unit and the grounding unit, and a second radiating unit, coupled to the shorting unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of a multi-band antenna according to an embodiment of the present invention.

FIG. 1B is a schematic diagram of signal paths of the multi-band antenna in FIG. 1A.

FIG. 1C is a schematic diagram of a voltage standing wave ratio of the multi-band antenna shown in FIG. 1A.

FIG. 2A is a schematic diagram of a multi-band antenna according to an embodiment of the present invention.

FIG. 2B is a schematic diagram of a voltage standing wave ratio of the multi-band antenna shown in FIG. 2A.

FIG. 3A is a schematic diagram of a multi-band antenna according to an embodiment of the present invention.

FIG. 3B is a schematic diagram of a voltage standing wave ratio of the multi-band antenna shown in FIG. 3A.

FIG. 4A is a schematic diagram of a multi-band antenna according to an embodiment of the present invention.

FIG. 4B is a schematic diagram of a voltage standing wave ratio of the multi-band antenna shown in FIG. 4A.

FIG. 5A is a schematic diagram of a multi-band antenna according to an embodiment of the present invention.

FIG. 5B is a schematic diagram of a voltage standing wave ratio of the multi-band antenna shown in FIG. 5A.

FIG. 6A is a schematic diagram of a multi-band antenna according to an embodiment of the present invention.

FIG. 6B is a schematic diagram of a voltage standing wave ratio of the multi-band antenna shown in FIG. 6A.

FIG. 7A and FIG. 7B are schematic diagrams of multi-band antennas according to embodiments of the present invention.

FIG. 8A is a schematic diagram of a multi-band antenna according to an embodiment of the present invention.

FIG. 8B is a schematic diagram of a voltage standing wave ratio of the multi-band antenna shown in FIG. 8A.

FIG. 9A is a schematic diagram of a multi-band antenna according to an embodiment of the present invention.

FIG. 9B is a schematic diagram of a voltage standing wave ratio of the multi-band antenna shown in FIG. 9A.

FIG. 10A to FIG. 10D are schematic diagrams of multi-band antennas according to embodiments of the present invention.

FIG. 11A is a schematic diagram of a multi-band antenna according to an embodiment of the present invention.

FIG. 11B is a schematic diagram of a voltage standing wave ratio of the multi-band antenna shown in FIG. 11A.

### DETAILED DESCRIPTION

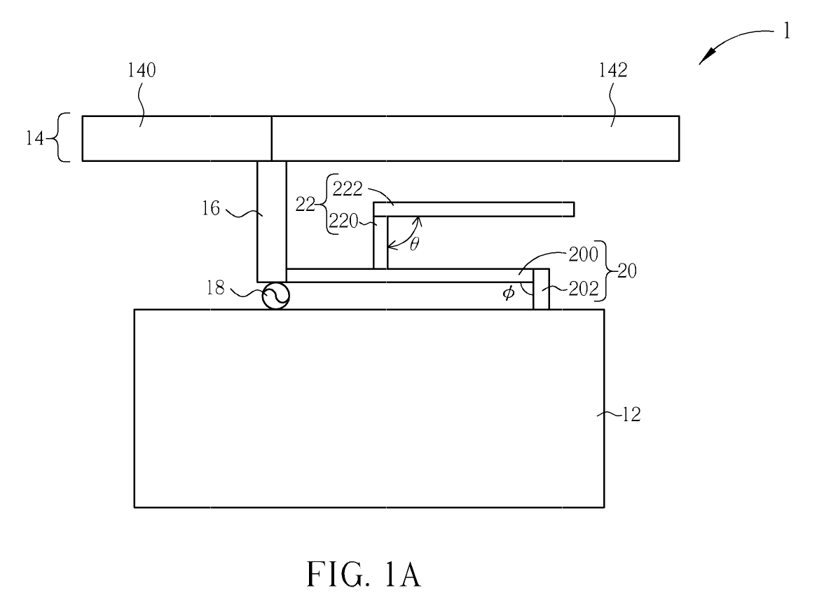

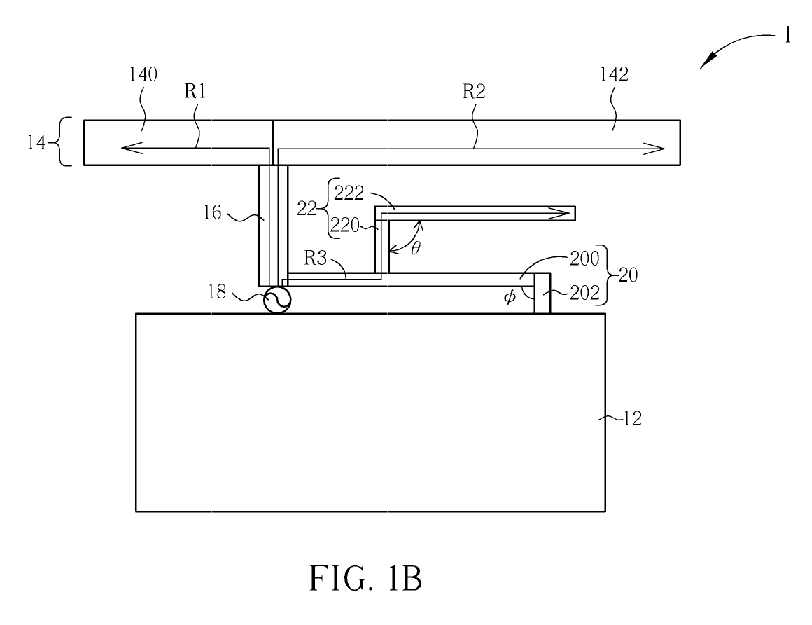

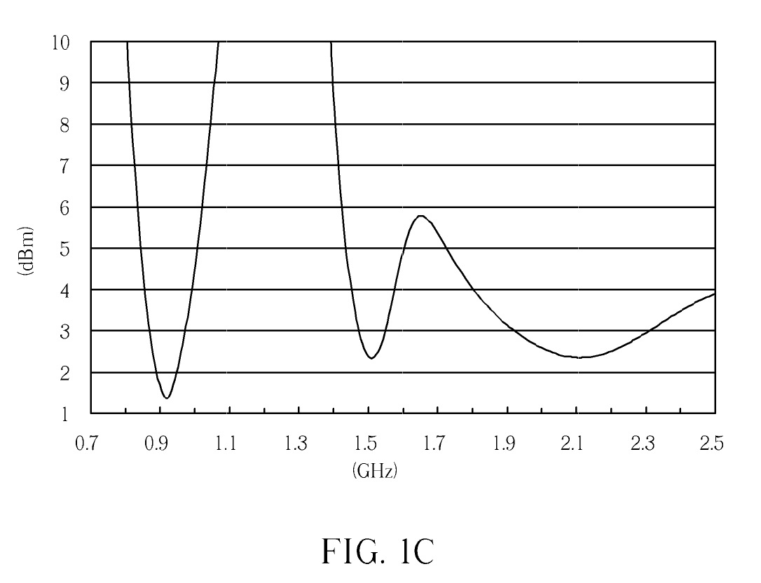

Please refer to FIG.1A, which is a schematic diagram of a multi-band antenna 1 according to an embodiment of the present invention. The multi-band antenna 1 is utilized in a wireless communication device (such as a notebook computer), and comprises a grounding unit 12, a first radiating unit 14, a connecting unit 16, a feeding unit 18, a shorting unit 20 and a second radiating unit 22. The grounding unit 12 is coupled to a ground, and utilized for providing grounding. The first radiating unit 14 comprises a first radiating element 140 and a second radiating element 142, and is utilized for transmitting radio waves. The feeding unit 18 is coupled between the connecting unit 16 and the grounding unit 12, and utilized for receiving feeding signals, so as to transmit the feeding signals to the first radiating unit 14 via the connecting unit 16. The shorting unit 20 is coupled between the connecting unit 16 and the grounding unit 12, and comprises a first shorting element 200 and a second shorting element 202. An angle between the first shorting element 200 and the second shorting element 202 is preferably 90°. In addition, the second radiating unit 22 is coupled to the shorting unit 20, and utilized for providing extra signal paths, to reach a goal of multiple bands. The second radiating unit 22 comprises a first radiating element 220 and a second radiating element 222, and an angle between the first radiating element 220 and the second radiating element 222 is preferably 90°.

Please continue to refer to FIG. 1B, which is a schematic diagram of signal paths of the multi-band antenna 1. As illustrated in FIG. 1B, the multi-band antenna 1 generates three signal paths: R1, R2 and R3 respectively. The signal paths R1 and R2 start from the feeding unit 18, and pass through the connecting unit 16, the first radiating element 140 and the second radiating element 142, which are well known by those skilled in the art. The signal path R3 starts from the feeding unit 18, via a part of the shorting unit 20, and finally passes through the second radiating unit 22. That is, in addition to the signal paths R1 and R2, the present invention further provides the extra signal path R3, to achieve three bands.

Therefore, via the second radiating unit 22, the multi-band antenna 1 can provide the extra signal path R3, so as to generate three transmitting bands. In this case, the present invention can generate VSWR (voltage standing wave ratio) as shown in FIG. 1C by adjusting lengths, widths or materials of the first radiating unit 14 and the second radiating unit 22.

The present invention adds the extra second radiating unit 22 to the shorting unit 20, so as to provide the signal path R3. Note that, a shape, material, etc. of the second radiating unit 22 are not limited in any certain condition. Certainly, the present invention can further add other radiating units to the shorting unit 20, or can branch an extra radiating element over the second radiating unit 22, to provide more bands. Similarly, other units or elements can have similar changes, which are not limited. The following description respectively introduces variations of the second radiating unit 22, the shorting unit 20, and the first radiating unit 14, and note that, the present invention is not limited to the examples.

In FIG. 1A, the second radiating element 22 is composed of the first radiating element 220 and the second radiating element 222, perpendicular to each other. Practically, the angle between the first radiating element 220 and the second radiating element 222 is not limited to 90°, and can be greater than or smaller than 90° according to different requirements. In addition, a shape of the second radiating unit 22 is not limited to an “L” shape formed by the first radiating element 220 and the second radiation 222, and can be arc-shaped or an inclined plane formed by a single metal arm.

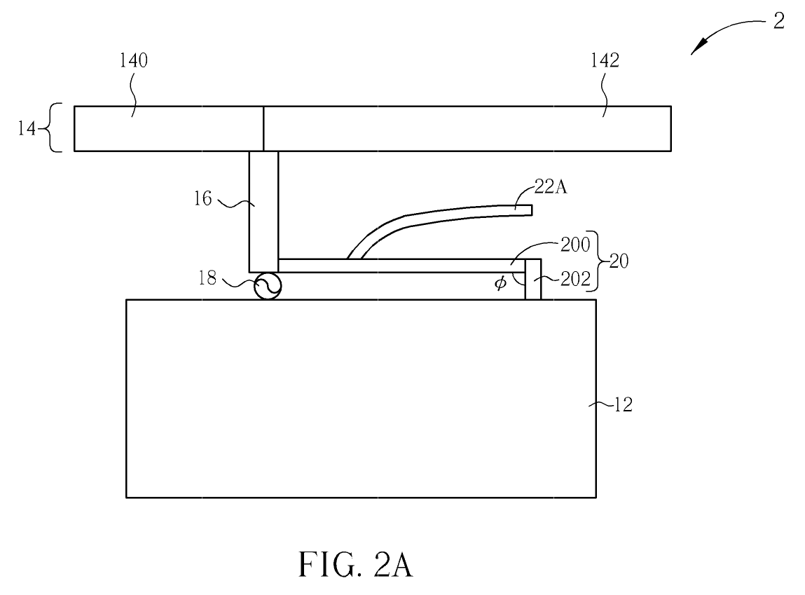

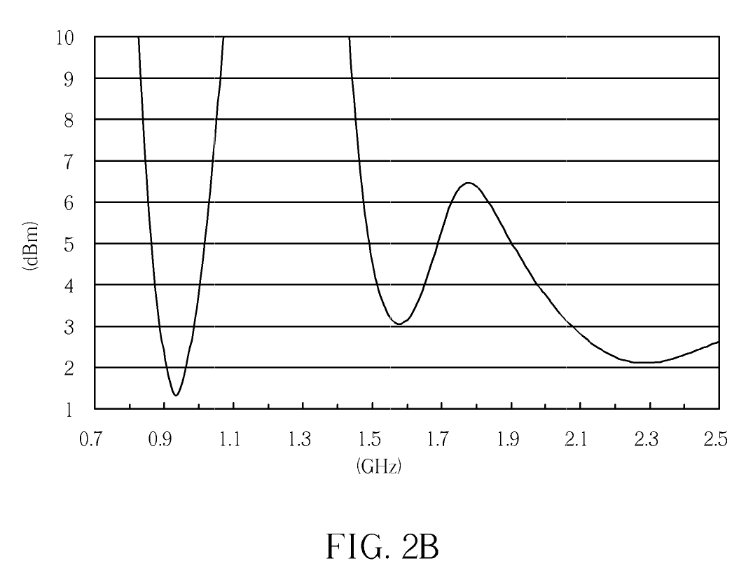

For example, please refer to FIG. 2A, which is a schematic diagram of a multi-band antenna 2 according to an embodiment of the present invention. A structure of the multi-band antenna 2 is similar to that of the multi-band antenna 1, while the difference is that the second radiating unit 22 of the multi-band antenna 1 is replaced by an arc-shaped second radiating unit 22A in the multi-band antenna 2. In this case, VSWR of the multi-band antenna 2 is shown in FIG. 2B, which can generate three bands.

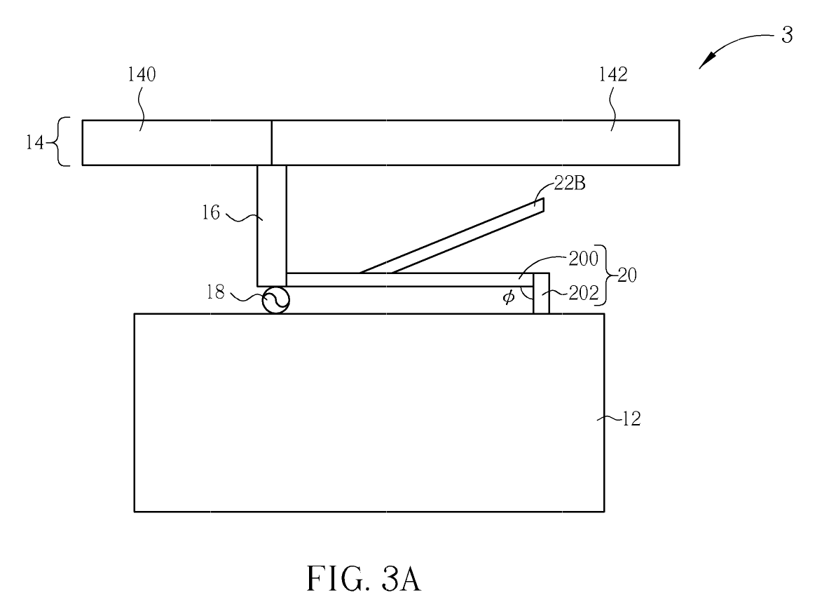

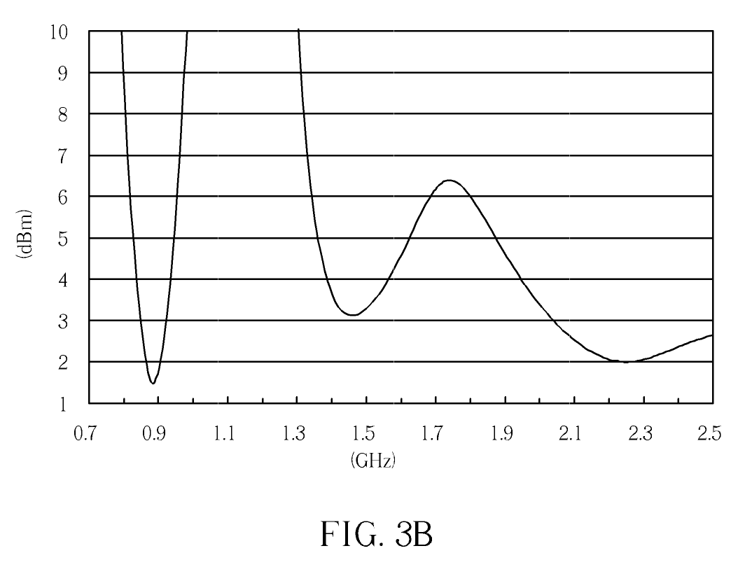

Similarly, please refer to FIG. 3A, which is a schematic diagram of a multi-band antenna 3 according to an embodiment of the present invention. A structure of the multi-band antenna 3 is similar to that of the multi-band antenna 1, while the difference is that the second radiating unit 22 of the multi-band antenna 1 is replaced by a second radiating unit 22B having an inclined plane in the multi-band antenna 3. In this case, VSWR of the multi-band antenna 3 is shown in FIG. 3B, which can generate three bands.

Except changing the shape of the second radiating unit 22, the present invention can further change a position connected between the second radiating unit 22 and the shorting unit 20.

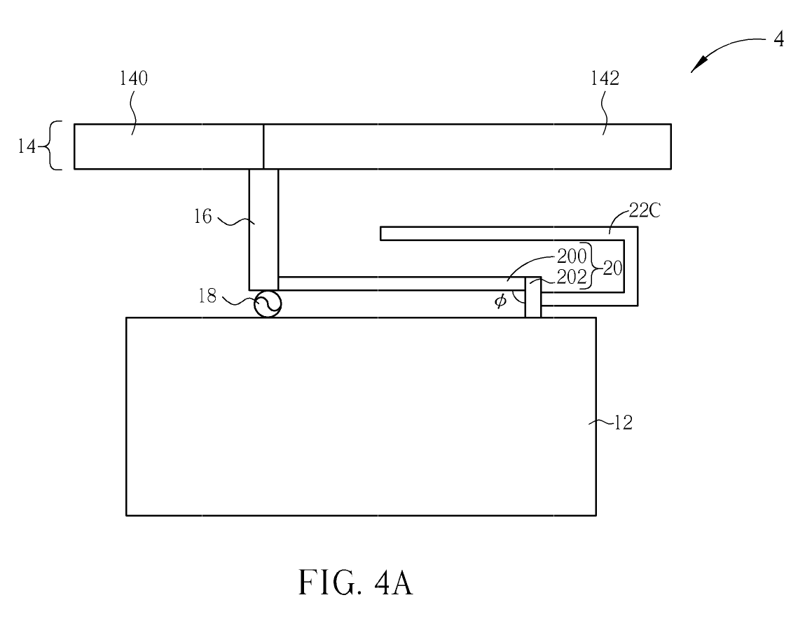

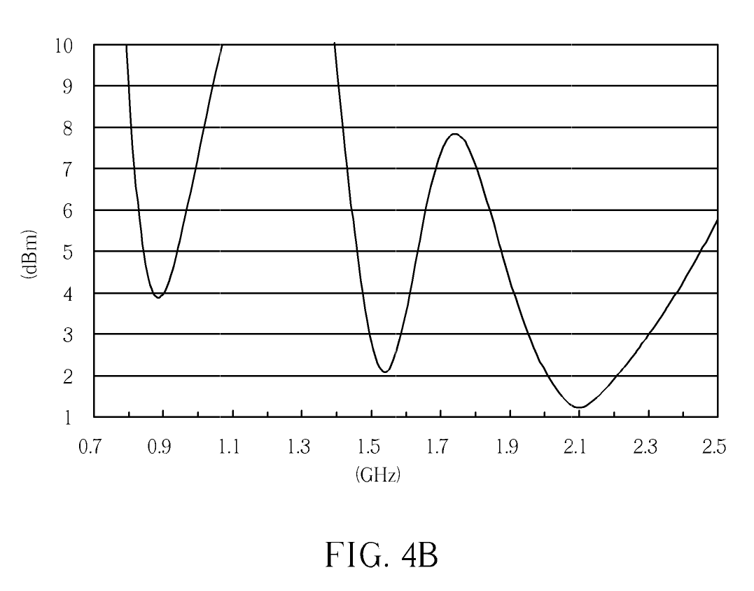

For example, please refer to FIG. 4A, which is a schematic diagram of a multi-band antenna 4 according to an embodiment of the present invention. A structure of the multi-band antenna 4 is similar to that of the multi-band antenna 1, while the difference is that the second radiating unit 22 of the multi-band antenna 1 is replaced by a second radiating unit 22C, composed of three radiating elements, in the multi-band antenna 4. Meanwhile, the second radiating unit 22C is coupled to the second shorting element 202 of the shorting unit 20. In this case, VSWR of the multi-band antenna 4 is shown in FIG. 4B, which can generate three bands.

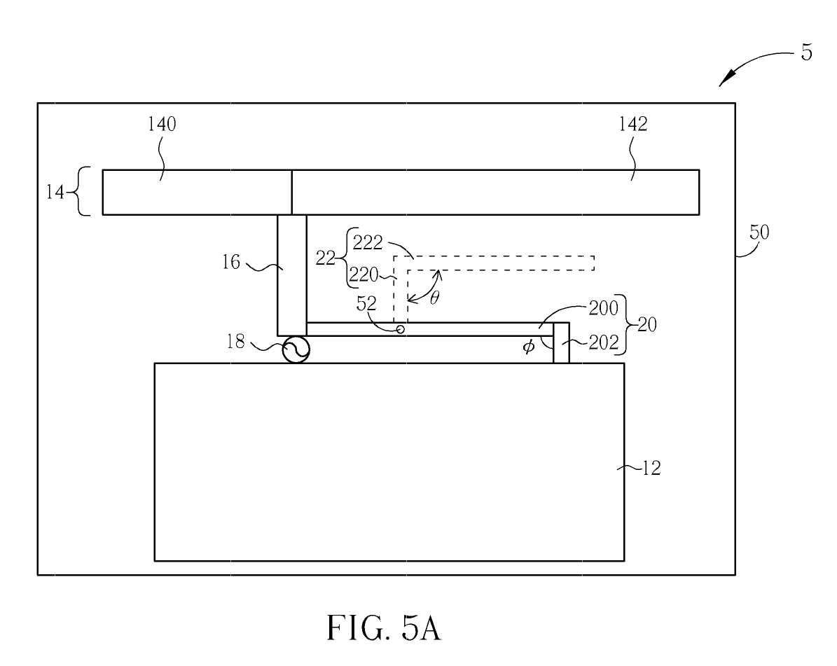

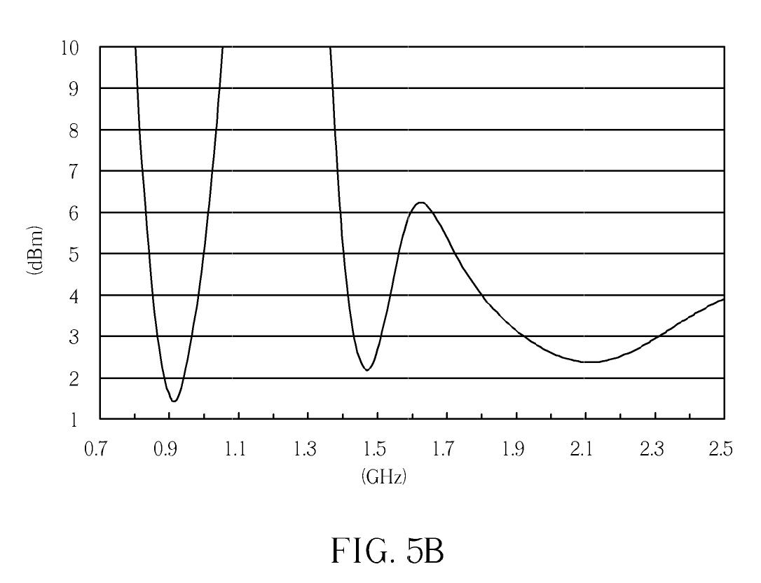

Moreover, when realizing the multi-band antenna of the present invention, the present invention can use multi-layer printed circuit board other than iron sheets, to realize the multi-band antenna according to different requirements. For example, please refer to FIG.5A, which is a schematic diagram of a multi-band antenna 5 according to an embodiment of the present invention. A structure of the multi-band antenna 5 is similar to that of the multi-band antenna 1, while the difference is that the multi-band antenna 5 is formed on a substrate 50, the grounding unit 12, the first radiating unit 14, the connecting unit 16, the feeding unit 18 and the shorting unit 20 are formed on a front plane of the substrate 50, and the second radiating unit 22 is formed on a rear plane of the substrate 50. In addition, the second radiating unit 22 and the shorting unit 20 are connected by a via 52. In this case, VSWR of the multi-band antenna 5 is shown in FIG. 5B, which can generate three bands.

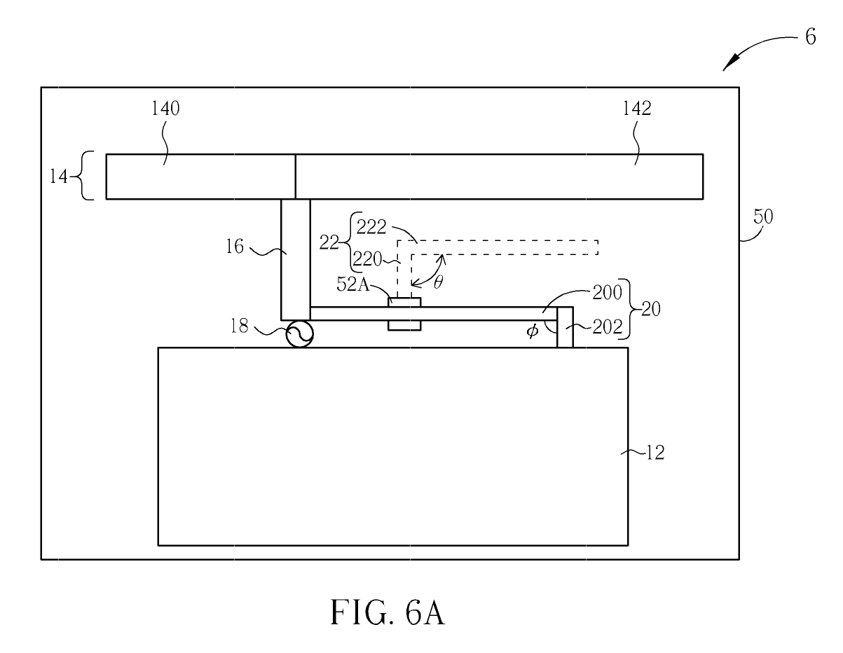

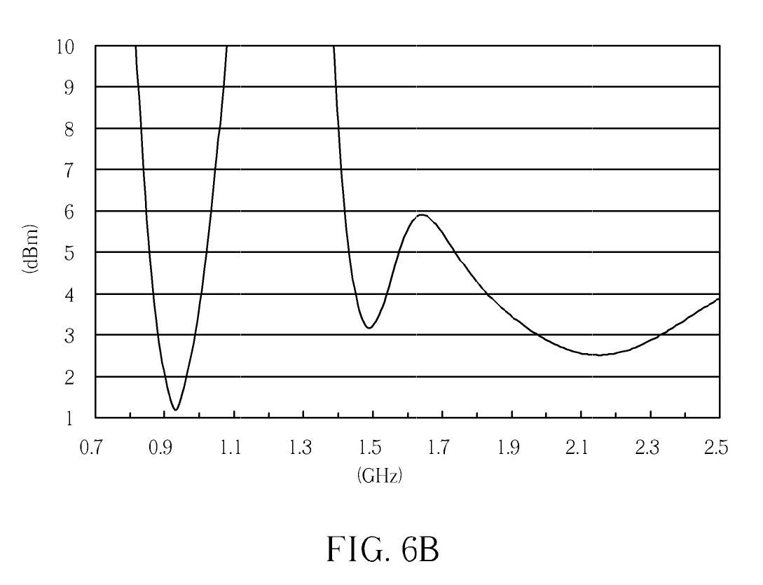

Except the via 52, the present invention can use various connecting units to connect the second radiating unit 22 and the shorting unit 20. For example, please refer to FIG. 6A, which is a schematic diagram of a multi-band antenna 6 according to an embodiment of the present invention. A structure of the multi-band antenna 6 is similar to that of the multi-band antenna 5, while the difference is that a coupling element 52A is used in the multi-band antenna 6 to connect the second radiating unit 22 and the shorting unit 20. In this case, VSWR of the multi-band antenna 6 is shown in FIG. 6B, which can generate three bands.

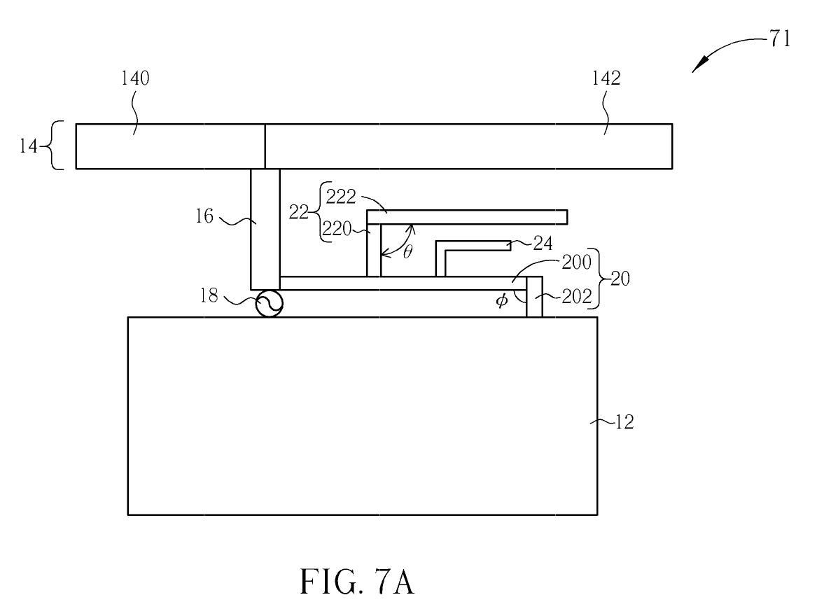

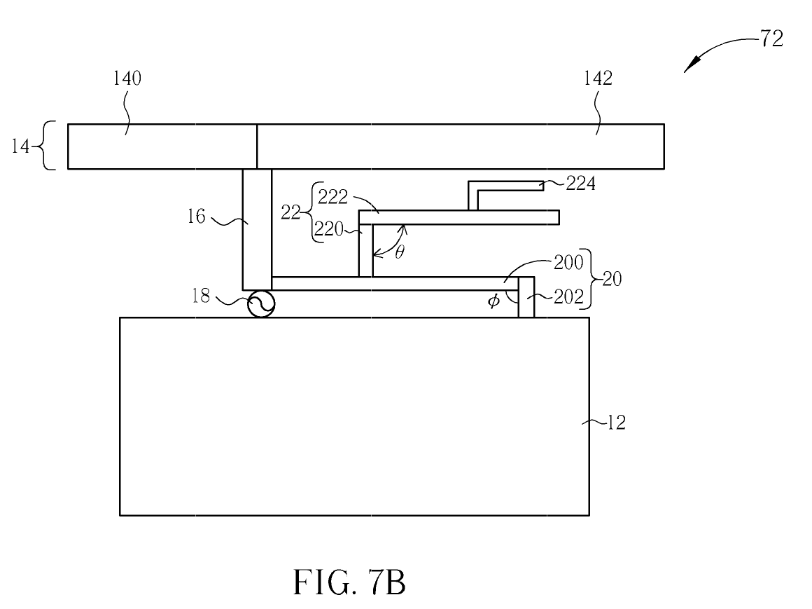

As shown in FIG. 2A, 2B to FIG. 6A, 6B, shape, position, connecting method of the second radiating unit 22 can be varied, and are not limited to these embodiments. In addition, the present invention can further add other radiating units to the shorting unit 20 or add other radiating elements to the second radiating unit 22, to achieve the goal of multiple bands. For example, please refer to FIG. 7A and FIG. 7B, which are schematic diagrams of multi-band antennas 71, 72 according to embodiments of the present invention. Structures of the multi-band antennas 71, 72 are similar to the structure of the multi-band antenna 1, while the difference is that an extra third radiating unit 24 is added to the shorting unit 20 of the multi-band antenna 71, and an extra third radiating element 224 is added to the second radiating unit 22 of the multi-band antenna 72. Note that, FIG. 7A and FIG. 7B are only utilized for illustrating variations of the present invention, and those skilled in the art can adjust an amount of the radiating units in the shorting unit 20 or an amount of the radiating elements in the second radiating unit 22 according to different requirements.

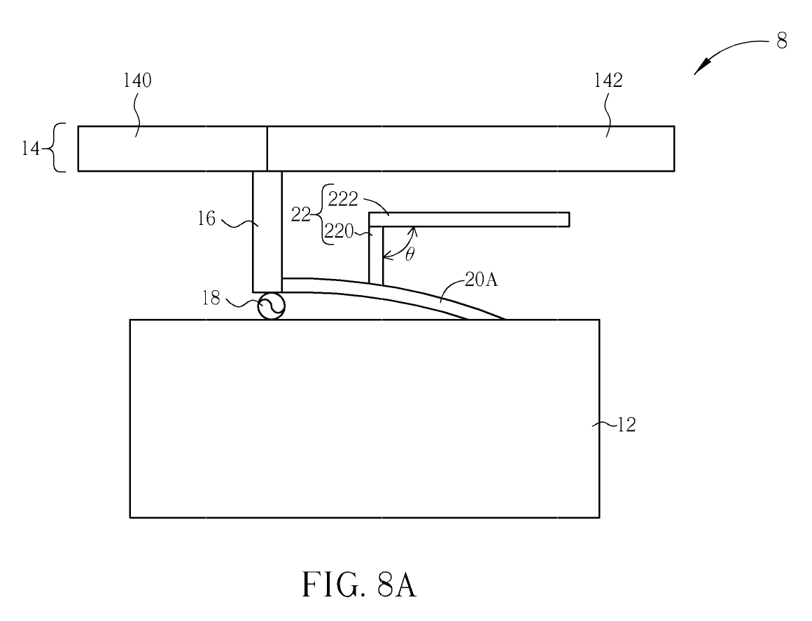

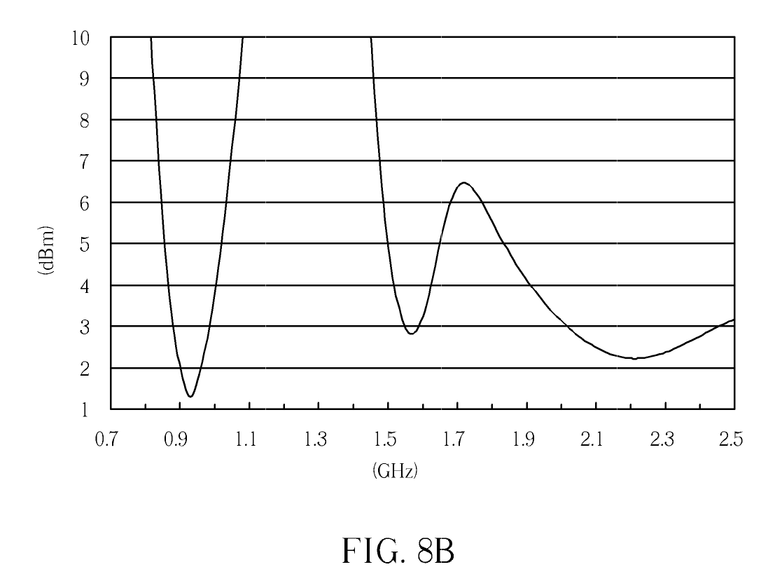

The following starts to introduce variation of the shorting unit 20. Please refer to FIG. 8A, which is a schematic diagram of a multi-band antenna 8 according to an embodiment of the present invention. A structure of the multi-band antenna 8 is similar to that of the multi-band antenna 1, while the difference is that the shorting unit 20 of the multi-band antenna 1 is replaced by an arc-shaped shorting unit 20A in the multi-band antenna 8. In this case, VSWR of the multi-band antenna 8 is shown in FIG. 8B, which can generate three bands.

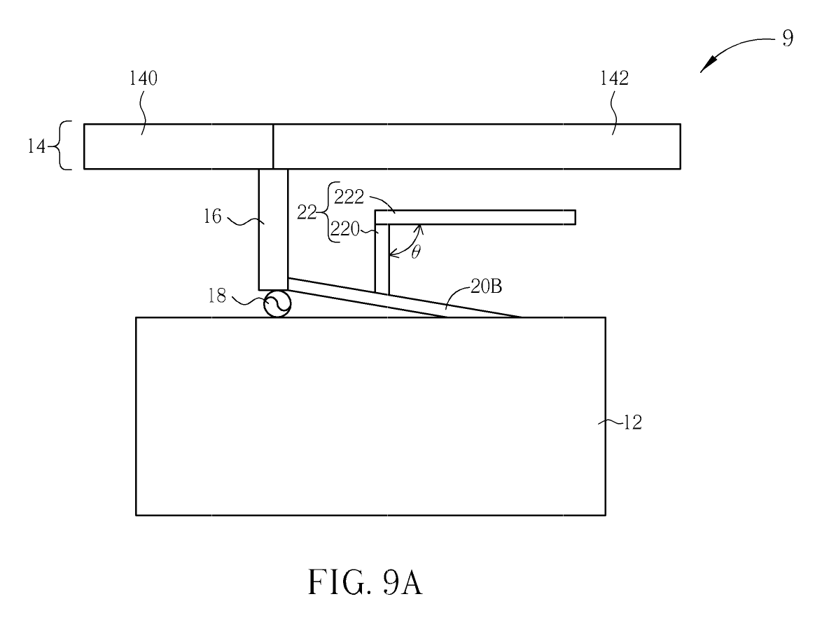

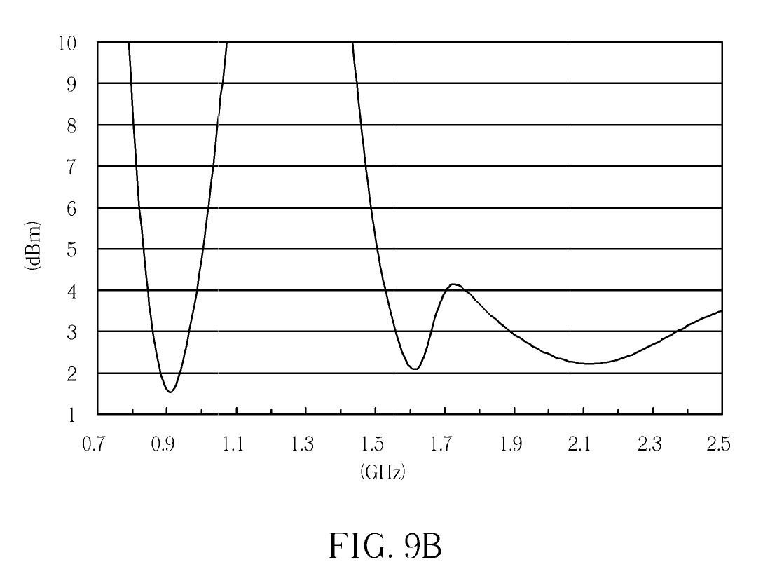

Similarly, please refer to FIG. 9A, which is a schematic diagram of a multi-band antenna 9 according to an embodiment of the present invention. A structure of the multi-band antenna 9 is similar to that of the multi-band antenna 1, while the difference is that the shorting unit 20 of the multi-band antenna 1 is replaced by a shorting unit 20B having an inclined plane in the multi-band antenna 9. In this case, VSWR of the multi-band antenna 9 is shown in FIG. 9B, which can generate three bands.

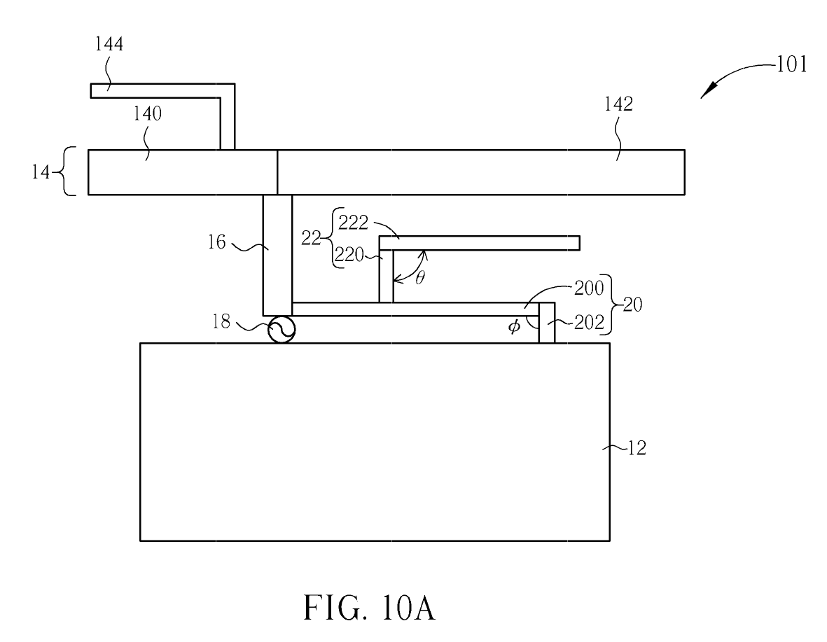

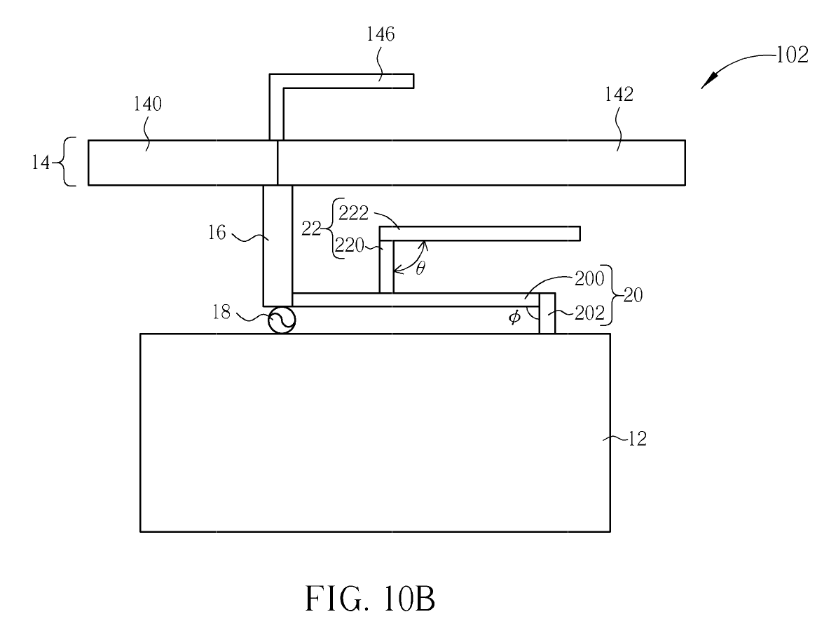

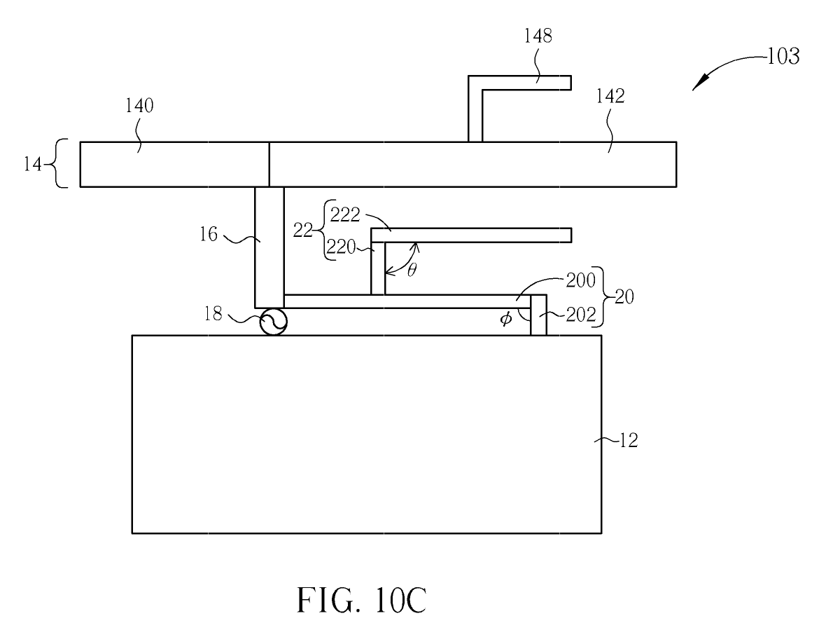

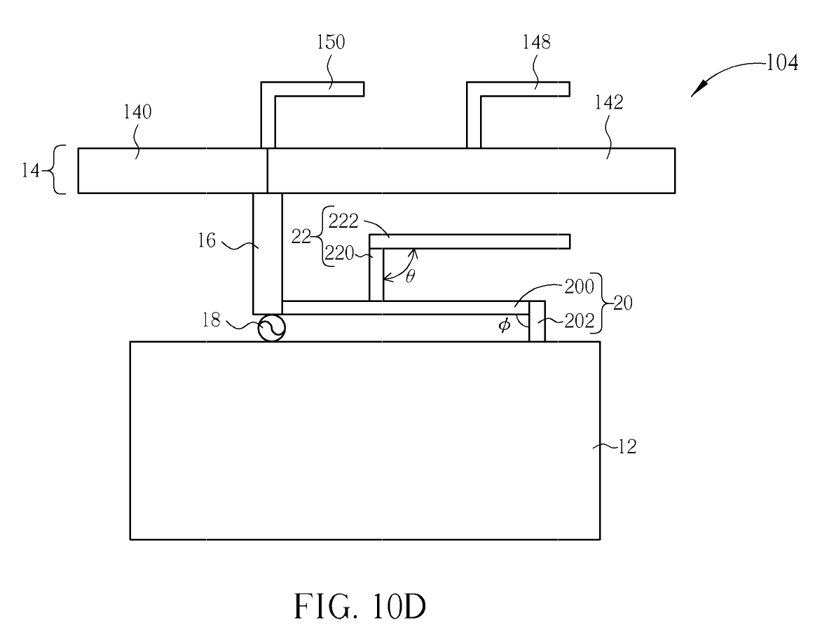

Finally, introduce variation of the first radiating unit 14. Please refer to FIG. 10A to FIG. 10D, which are schematic diagrams of multi-band antennas 101, 102, 103 and 104 according to embodiments of the present invention. Structures of the multi-band antennas 101, 102, 103 and 104 are similar to the structure of the multi-band antenna 1, while the difference is that extra radiating elements are added to the first radiating unit 14 in the multi-band antennas 101, 102, 103 and 104. In the multi-band antenna 101, a third radiating element 144 is added to the first radiating element 140 of the first radiating unit 14. In the multi-band antenna 102, a third radiating element 146 added to a boundary between the first radiating element 140 and the second radiating element 142 of the first radiating unit 14. In the multi-band antenna 103, a third radiating element 148 is added to the second radiating element 142 of the first radiating unit 14. In the multi-band antenna 104, except the third radiating element 148, a fourth radiating element 150 is added to the boundary between the first radiating element 140 and the second radiating element 142. Note that, FIG. 10A to FIG. 10D are utilized for illustrating the embodiments of the present invention, and those skilled in the art can adjust an amount of the radiating elements included in the first radiating unit 14 according to different requirements, which is not limited to these embodiments.

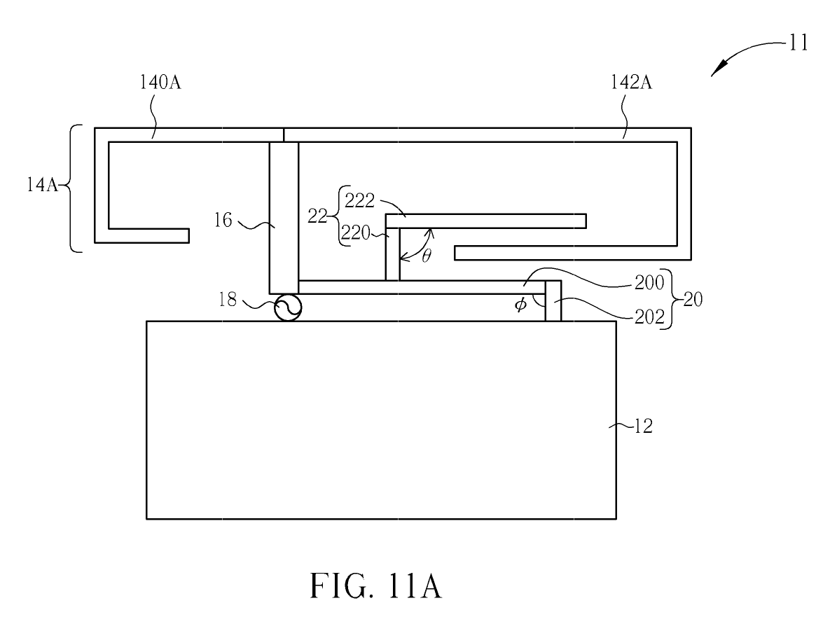

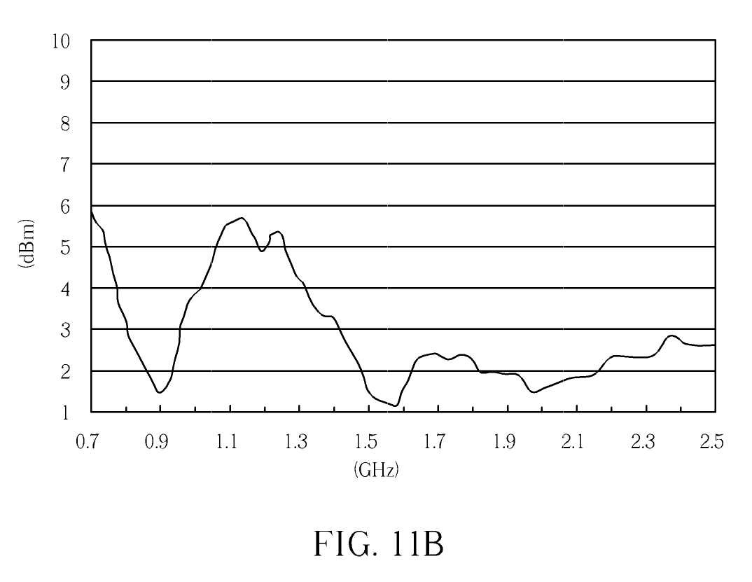

In addition, a shape of the first radiating unit 14 is not limited to a certain category. For example, please refer to FIG. 11A, which is a schematic diagram of a multi-band antenna 11 according to an embodiment of the present invention. A structure of the multi-band antenna 11 is similar to that of the multi-band antenna 1, while the difference is that the first radiation 14 of the multi-band antenna 1 is replaced by a first radiating unit 14A in the multi-band antenna 11. The first radiating unit 14A comprises a first radiating element 140A and a second radiating element 140B, and both have bending structures. In this case, VSWR of the multi-band antenna 11 is shown in FIG. 11B, which can generate three bands.

Note that, the aforementioned embodiments are utilized for illustrating merits of the present invention. Those skilled in the art can make modification and variation according to different requirements. Meanwhile, the embodiments are not applied independently, and can be cooperated.

To sum up, the present invention adds extra radiating units to the shorting unit of the multi-band antenna, to provide extra signal paths, so as to reach the goal of multiple bands. Therefore, through adjusting shape, scale, material, etc., of each element, the present invention can achieve a single antenna covering every band used in different wireless communication networks, to meet a main stream of reducing a size of a portable communication device.

Those skilled in the art will readily observe that numerous modifications and alterations of the device and method may be made while retaining the teachings of the invention.

What is claimed is:

1. A multi-band antenna for a wireless communication device comprising:
a grounding unit, coupled to a ground;
a first radiating unit;
a connecting unit, comprising a first end coupled to the first radiating unit, and a second end;
a feeding unit, coupled between the second end of the connecting unit and the grounding unit, for receiving feeding signals;
a shorting unit, coupled between the second end of the connecting unit and the grounding unit; and
a second radiating unit, coupled to the shorting unit.

2. The multi-band antenna of claim 1, wherein the first radiating unit comprises:
a first radiating element, coupled to the first end of the connecting unit, and extending along a first direction; and
a second radiating element, coupled to the first radiating element and the first end of the connecting unit, and extending along an opposite direction of the first direction.

3. The multi-band antenna of claim 2, wherein the first radiating element comprises at least a bending part.

4. The multi-band antenna of claim 2, wherein the second radiating element comprises at least a bending part.

5. The multi-band antenna of claim 1, wherein the shorting unit comprises:
a first shorting element, coupled to the second end of the connecting unit; and
a second shorting element, coupled between the first shorting element and the grounding unit.

6. The multi-band antenna of claim 5, wherein an angle between the first shorting element and the second shorting element is 90°.

7. The multi-band antenna of claim 5, wherein the second radiating unit is coupled to the first shorting element.

8. The multi-band antenna of claim 5, wherein the second radiating unit is coupled to the second shorting element.

9. The multi-band antenna of claim 1, wherein the shorting unit is arc-shaped.

10. The multi-band antenna of claim 1, wherein the shorting unit is a metal arm.

11. The multi-band antenna of claim 1, wherein the second radiating unit comprises:
a first radiating element, coupled to the shorting unit; and
a second radiating element, coupled to the first radiating element.

12. The multi-band antenna of claim 11, wherein an angle between the first radiating element and the second radiating element is 90°.

13. The multi-band antenna of claim 11, wherein the second radiating unit further comprises a third radiating element, coupled to the second radiating element.

14. The multi-band antenna of claim 1 further comprising a third radiating element, coupled to the shorting unit.

15. The multi-band antenna of claim 1, wherein the second radiating unit is arc-shaped.

16. The multi-band antenna of claim 1, wherein the second radiating unit is a metal arm.

17. The multi-band antenna of claim 1 further comprising a substrate, comprising a first plane and a second plane, wherein the grounding unit, the first radiating unit, the feed unit, the connecting unit and the shorting unit are formed on the first plane, and the second radiating unit is formed on the second plane.

18. The multi-band antenna of claim 17 further comprising a via, coupled between the second radiating unit and the shorting unit.

19. The multi-band antenna of claim 17 further comprising a coupling unit, coupled between the second radiating unit and the shorting unit.

20. The multi-band antenna of claim 1, wherein the wireless communication device is a notebook computer.
